(19) United States
(12) Patent Application Publication
(10) Pub. No.: US 2026/0132651 A1
(43) Pub. Date: May 14, 2026

(54) Mounting Assembly for Pool Side and In-Pool Umbrellas and Umbrella Accessories

(71) Applicant: Wolfgang Rendy Looke, Chandler, AZ (US)

(72) Inventor: Wolfgang Rendy Looke, Chandler, AZ (US)

(21) Appl. No.: 19/172,531

(22) Filed: Apr. 7, 2025

Related U.S. Application Data
(60) Provisional application No. 63/720,119, filed on Nov. 13, 2024.

(51) Int. Cl. E04H 12/22; A45B 23/00; E04H 4/14; H02S 20/20

(52) U.S. Cl. CPC E04H 12/2269; A45B 23/00; E04H 4/14; H02S 20/20; A45B 2023/0012; A45B 2200/1027; A45B 2200/1063

(57) ABSTRACT

Systems and methods for securing an umbrella pole to a pool-side or in-pool pole mount hole to permit the use of umbrella poles having a diameter less than, equal to, or greater than the diameter of the originally installed pole hole. Systems include a base plate surrounding (e.g., circumferentially covering) the pole hole and having a bottom surface resting on the deck or pool bottom surface, an elongated (e.g., cylindrical) section extending downwardly from the of the bottom (e.g., center) of the base plate and receivable within the pole hole, and a pole support section extending upwardly from the top surface of the base plate for receiving the distal (ground facing) end of an umbrella pole.

### REFERENCE TO RELATED APPLICATION

The present application claims priority to U.S. Provisional Application Ser. No. 63/720,119, entitled MOUNTING ASSEMBLY FOR POOL SIDE AND IN-POOL UMBRELLAS, filed Nov. 13, 2024, the entire contents of which are hereby incorporated by reference.

### TECHNICAL FIELD

The present invention relates, generally, to sun shade umbrellas designed to be installed around swimming pools, and more particularly an improved umbrella pole mounting assembly that interfaces with standard umbrella holes found in pool decks and underwater shelves.

### BACKGROUND

Presently known techniques for mounting umbrellas to pool decks and underwater swimming pool shelves involve sliding the bottom (distal) end of an umbrella pole into a pre-installed hole in the pool deck or underwater step or shelf, often referred to as a Baja Shelf or Cabo Shelf. Often, however, the hole diameter and/or hole depth is too small to accommodate larger umbrella poles. Moreover, even if the pole fits snugly within the inner diameter of the pole hole, the depth of the pole hole may not be sufficient to allow the umbrella to maintain stability in windy conditions or due to excessive weight or bending in the pole.

In-ground swimming pools are often installed with one or more cylindrical umbrella holes, typically about 1.5 to 2 inches in diameter and extending up to about six inches deep into the pool bottom or pool deck. An umbrella pole sleeve is secured into the hole with adhesive or other permanent mounting substance to prevent water from flowing into and through the bottom of the hole and to slidably and removably secure the distal end of the umbrella pole.

Presently known umbrella systems are disadvantageous in that they can become unstable in windy conditions, if they are excessively tall, or if the outer diameter of the bottom of the pole is appreciably smaller than the hole sleeve within which the bottom of the umbrella pole rests. In addition, most umbrella pole holes installed in pool decks and underwater shelfs are “one size fits all,” making it difficult if not impossible to upgrade the umbrella pole to one having a bottom diameter larger than the inner diameter of the pole hole sleeve.

Pool side and in-pool umbrella anchoring systems are thus needed which overcome the foregoing shortcomings of existing systems.

### SUMMARY OF THE INVENTION

In accordance with an embodiment of the invention, an umbrella anchoring system is provided which includes: i) a first cylindrical section configured for vertical disposition within an existing umbrella pole sleeve in a pool deck or underwater shelf; ii) a horizontal base plate secured to a top portion of the first cylindrical section such that the bottom of the base plate rests on the horizontal surface of the pool deck or underwater shelf when the first cylindrical section is disposed within the pole hole; and iii) an umbrella pole support extending upwardly from the base plate and configured to receive an umbrella pole therewithin. As described below, the pole support may accommodate poles having outer diameters greater than, less than, or equal to the inner diameter of the original pool deck or pool shelf pole hole sleeve.

In an exemplary embodiment, the anchoring system may be assembled into rigid, unitary construction such that the various components are substantially immovable relative to each other, except for an optional degree of resilient deformability designed to resist and restore transient deformation (e.g., bending) due to wind or manual loads applied to the umbrella structure which may occur when attaching accessories to the assembly or using those accessories, as explained in greater detail below. Such a unitary construction also allows the anchor assembly to be placed into the pole hole, and an umbrella pole placed into the pole support sleeve, by a single person working alone and without the need for tools.

A further embodiment includes a securing mechanism to snugly retain the umbrella pole within the pole support sleeve, such as threaded tightening screws disposed on the outer diameter of the pole support and extending through the circumferential wall of the pole support, generally analogous to the manner in which a Christman tree is secured within a tree stand. Alternatively, or in addition, a spring loaded or similar collar may be secured about the upper end of the pole support and configured to also grasp the outer diameter of the umbrella pole proximate the upper end of the pole support. In an embodiment, the screw heads may be equipped with radially extending wings which may include a pliable material to facilitate manual tightening and loosening of the screws. These techniques may advantageously dampen or even prevent undesirable rotational and axial movement of the umbrella pole relative to the pole support, particularly during windy conditions.

In a further embodiment, a resilient collar, or one or more O-rings may be disposed about the outer diameter of the distal end of the first cylindrical section of the anchor assembly to tightly retain the anchor assembly within the original pole hole or pole hole sleeve. Alternatively, or in addition, a resilient collar and/or one or more O-rings may be disposed about the inner diameter of the pole hole.

In a further embodiment, the first cylindrical section, the base plate, and the pole support may comprise a single piece of unitary construction, such as a cast or injection molded piece. Alternatively, the anchor assemble may comprise two or more pieces which are press fit, screwed together, or releasably secured together through a quick release mechanism. For example, the upper end of the pole support may threadably engage an inner diameter of a through hole extending through the base plate, the pole support, or both. Alternatively, the first cylindrical section and the pole support may be of single, unitary construction, whereupon the base plate is secured (e.g., threadably or through welding) to the assembly comprising the first cylindrical section and the pole support, for example proximate the junction therebetween. In a further embodiment, one or more of the base plate, the first cylindrical section, and the pole support may comprise a rigid material such as aluminum 7075 treated with, for example, a medium blue anodized hard coat.

In a further embodiment, the base plate may include a plurality of dots, plugs, circular, elongated, rectilinear, or other shaped resiliently deformable material (e.g., rubber) integrated into or otherwise secured (e.g., adhesively) to the bottom surface of the plate to prevent scratching, cracking, and/or denting the deck or underwater pool surface. Alternatively, or in addition, the base plate may be disc shaped, star shaped, or it may comprise a plurality of fingers extending from a central hub. In an embodiment, the star arms or fingers may comprise a resiliently deformable material to resist and/or restore stresses imposed on the plate due to wind or other circumstances.

In a further embodiment, the junction between the base plate and the pole support may comprise a resiliently deformable material to resist and/or restore bending stresses due to wind.

In a further embodiment, one or more of the foregoing resiliently deformable components may be equipped with a strain gauge operably connected to a communications module to remotely alert the user to remove the umbrella during high wind conditions resulting in measured strain or displacement exceeding a predetermined threshold.

In a further embodiment the anchoring system may comprise one or more optical and/or acoustic sensors to detect the presence of a human or animal and alert the homeowner that a child or trespassers may be in the vicinity of the swimming pool.

Various other embodiments, aspects, and features are described below.

### BRIEF DESCRIPTION OF THE DRAWING FIGURES

Various embodiments are hereinafter described in conjunction with the appended drawing figures, where like numerals denote like elements, and:

FIG. 1 is a front elevation view of a pool-side or in-pool umbrella anchor assembly 100 in accordance with the present invention;

FIG. 2 is a cross-section view of a tightening mechanism for securing the anchor assembly into the pole hole in accordance with the present invention;

FIG. 3 is front elevation view of an alternate embodiment of the anchor assembly showing a first section with an inner diameter for receiving an optional guide pin (not shown) in accordance with the present invention;

FIG. 4 is side elevation view of the anchor assembly shown in FIG. 1 in accordance with the present invention;

FIG. 5 is front elevation view of an alternate embodiment of the anchor assembly showing screw threaded engagement of the first section, base plate, and pole support in accordance with the present invention;

FIG. 6 is a close-up view of an umbrella pole configured to be slidably received within the pole support in accordance with the present invention;

FIG. 7 is front elevation view of an alternate embodiment of the anchor assembly showing a beveled base plate in accordance with the present invention;

FIG. 8 is top view of an alternate embodiment of the anchor assembly showing an unfolded umbrella equipped with a photovoltaic device such as a solar panel in accordance with the present invention;

FIG. 9 is a side elevation view of an embodiment of the anchor assembly of FIG. 8 showing a terminal device such as a USB charger connected to a distal end of a wire extending from the solar panel in accordance with the present invention;

FIG. 10 is top view of an exemplary embodiment of the USB port and distal end of the connecting wire shown in FIG. 9 in accordance with the present invention;

FIG. 11 is close up view of the solar panel and connecting wire shown in FIGS. 9 and 10 in accordance with the present invention;

FIG. 12 is a perspective view of an alternate embodiment of the anchor assembly showing an optional table mounted proximate the top end of the pole support in accordance with the present invention;

FIG. 13 is a perspective view of an alternate embodiment of the anchor assembly showing an optional table mounted proximate the top end of the pole support showing the table top separated into half sections in accordance with the present invention;

FIG. 14 is a schematic top plan view of a portion of the top surface of the table shown in FIG. 13 showing exemplary dimensions for cut-outs in accordance with the present invention;

FIG. 15 is a side elevation view of an exemplary embodiment of the table of FIGS. 13 and 14 shown mounted proximate the top end of the pole support with a plurality of angled brackets in accordance with the present invention;

FIG. 16 is a perspective view of the table shown in FIG. 12 when viewed from the underside of the table in accordance with the present invention;

FIG. 17A is a top plan view of the pole support and table mounting brackets with the table top removed for clarity in accordance with the present invention;

FIG. 17B is a side elevation view of the table, table mounting brackets, and pole support in accordance with the present invention;

FIG. 18 is bottom plan view of the table shown in FIG. 17B in accordance with the present invention;

FIG. 19 is a side elevation view of an alternate embodiment of the anchor assembly system showing an optional accessory such as stereo speakers mounted to the pole support via a bracket extending through a relief in the table top and powered through a charging port such as a USB port in accordance with the present invention;

FIG. 20 is a perspective view of the underside of a table secured to an attachment bracket in accordance with an embodiment of the invention;

FIG. 21 is a perspective view of an attachment bracket attached to the outer diameter of an umbrella support sleeve using a plurality of fasteners 2132 in accordance with an embodiment of the invention;

FIG. 22 is a side elevation view of an adapter tube in accordance with an embodiment of the invention;

FIG. 23 is a schematic front elevation view of an adapter pin in accordance with an embodiment of the invention;

FIG. 24 is a partial perspective side elevation view of an adapter tube having a tightening cap in accordance with an embodiment of the invention;

FIG. 25 is a perspective view of an adapter tube, base plate, and adapter pin assembly in accordance with an embodiment of the invention;

FIG. 26 is a partial perspective view of a metallic original equipment manufacturer pool sleeve in accordance with an embodiment of the invention; and

FIG. 27 is a schematic view of a metallic original equipment manufacturer pool sleeve in accordance with an embodiment of the invention.

### DETAILED DESCRIPTION OF PREFERRED EXEMPLARY EMBODIMENTS

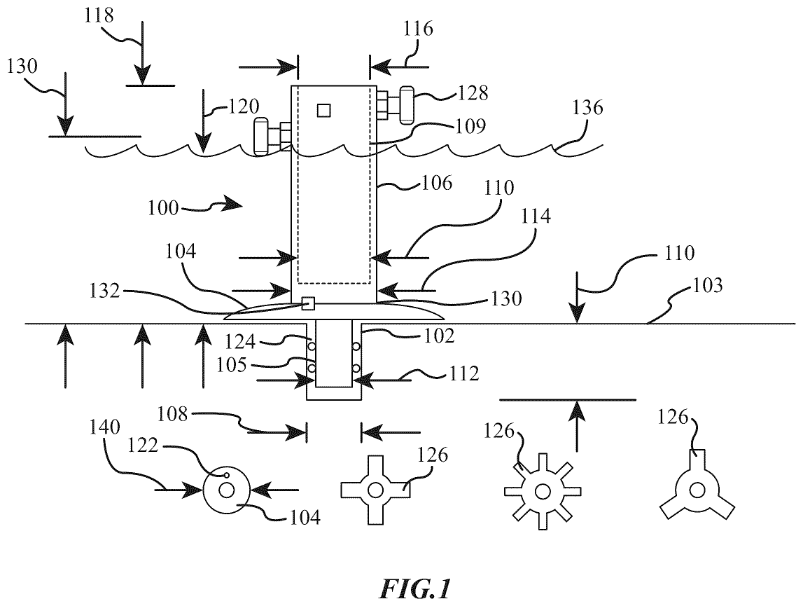

Referring now to FIG. 1, a pool-side or in-pool umbrella anchor assembly 100 suitably includes a base plate 104 having a first section 105 extending substantially orthogonally downward from the base plate and an umbrella pole support 106 extending substantially orthogonally upward from the base plate. Assembly 100 is configured to be slidably inserted into—and thereby secured in place by—a pole hole 102 installed through and beneath a surface 103 of a pool deck or underwater pool surface referred to herein as a step, Baja Shelf, Cabo Shelf, or the like.

In the illustrated embodiment, base plate 104 is configured to surround pole hole 102, with the first cylindrical section 105 extending vertically downward from base plate 104 and into pole hole 102 or into an optional pole hole sleeve (not shown for clarity) which may be received within pole hole 102. Pole support section 106 extends vertically upward from base pate 104 and is configured to slidably and removably receive the distal (bottom) end of an umbrella pole 109, as described in greater detail below.

Pre-installed umbrella holes 102 typically have an inner diameter 108 in the range of 1.5 to 2 inches. Accordingly, the effective outer diameter of section 105 is suitably approximately equal to or smaller than dimension 108. In this context, the effective diameter of section 105 may contemplate one or more O-rings 124 or collars (not shown) used to take up any excess slack between the dimension 108 and the circumferential surface of section 105. In one embodiment section 105 may be tapered, either immediately proximate the distal end or more generally along the length of section 105 to facilitate initial and/or final insertion of section 105 into hole 102.

In various embodiments, base plate 104 is fixedly secured to section 105 and pole support 106 by welding, screw threads, quick release mechanisms, interference (press) fittings, bolts, tab in groove, or any other permanent or temporary securing methods. Alternatively, one or more of base plate 105, section 105, and pole support 106 may be of unitary, integral construction such through casting, injection molding, or the like.

Underwater shelfs which include an umbrella pole hole, such as a Baja Shelf or Cabo Shelf, are typically in the range of dimension 120, such as 12 to 24 inches under water, and particularly about 18 inches under water. As such, the distance 188 by which the top of the pole support extends from the floor 103 should be sufficient to ensure that, when installed, the surface of the water is sufficiently below the top of the pole support to allow insertion and removal of the pole 116 into the pole support 106 in a dry environment. In addition, at least some of the tightening lugs 128, used to secure umbrella pole 116 within pole support 116, should be located at a distance 138 above the floor 103 and sufficiently above the water surface to allow manual manipulation (tightening and loosening) in a dry environment.

With continued reference to FIG. 1, assembly 100 further includes a device 132 which may comprise a strain gauge, accelerometer, or other sensor to monitor stress, strain, and/or slight displacement or bending of pole support 106 relative to base plate 104 due to wind or a collision with assembly 100 or a table or other accessory appurtenant thereto. In one embodiment, device 132 may also comprise a wired or wireless communications component to warn the homeowner or security personnel of potentially dangerous conditions, for example to advise the homeowner that weather conditions warrant removing the umbrella.

A second electronic device 134 may be disposed above or below the waterline and may include one or more of an audio (acoustic) or optical sensor along with a communications capability to warn the homeowner if an intruder, pet, or young child is in the vicinity of the pool.

FIG. 1 also illustrates a plurality of alternate base configurations such as a cross, starfish, or tripod to allow resilient deflection and restoration of the base during strong winds. In this way, rather than the umbrella pole breaking, bending, or being blown from the pole support, the stress applied by wind may be absorbed and dissipated via resilient deformation of the surrounding components. The fingers 126 of these base plate configurations may comprise a rigid or semi rigid metallic primary structure coated with hard plastic, rubber, or the like to avoid scratching or cracking the pool floor surface.

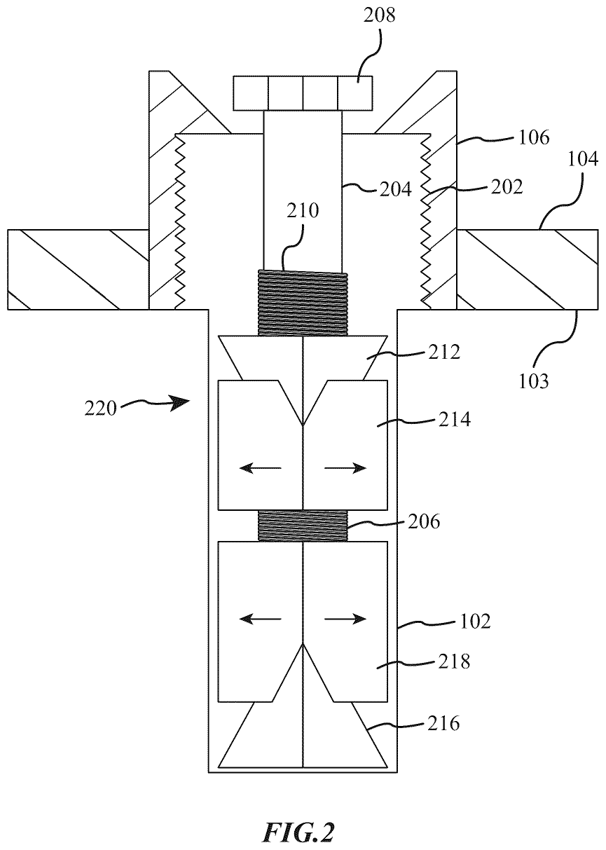

Referring now to FIG. 2, an alternate embodiment of an anchor assembly 200 includes an adjustable tightening mechanism for securing the anchor assembly into the pole hole. As illustrated, anchor assembly 200 comprises a base plate 104, an umbrella pole support sleeve 106 extending vertically upward from the base plate, and a securing mechanism 220 extending downwardly from the base plate into pole hole 102. Securing mechanism 220 comprises a screw 204 having a screw head 208 and respective upper and lower threads 210 and 206. Securing mechanism 220 further comprises a first conical dowel 212 configured for downward advancing receipt within a first radially expandable plug 214, and a second conical dowel 216 configured for advancing receipt within a second radially expandable plug 218.

When screw 204 is turned in a tightening direction, upper threads 210 engage corresponding threads disposed within an inner diameter (not shown) of dowel 212 causing dowel 212 to advance axially downward relative to and into plug 214 which, in turn, causes plug 214 to expand radially to circumferentially engage the inner diameter of pole hole 102, restricting axial movement (up and down) of securing mechanism 220 within the pole hole. In similar fashion, when screw 204 is tightened, lower threads 206 engage corresponding threads disposed within an inner diameter (not shown) of dowel 216 causing dowel 216 to advance axially upward relative to and into plug 218 which, in turn, causes plug 218 to expand radially and circumferentially engage the inner diameter of pole hole 102, further restricting axial movement (up and down) of securing mechanism 220 within the pole hole.

In accordance with a further aspect of the invention, the pitch, thread count, diameter, and direction of threads 210 may be the same or different than threads 206. In this way, plug 218 and dowel 216 may exhibit a higher effective gain than plug 214 and dowel 212, allowing the initial turns of screw 204 to secure the bottom plug, and subsequent screw turns could fine tune the system by thereafter securing the top plug.

With continued reference to FIG. 2, the illustrated components could also be arranged so that screw 204 also urges the baseplate/pole support subassembly downwardly against the pool floor 103. Alternatively, or in addition, once securing mechanism 220 is in place, the base plate 104 and pole support 106 may threadedly engage securing mechanism 220 to form an integral structure.

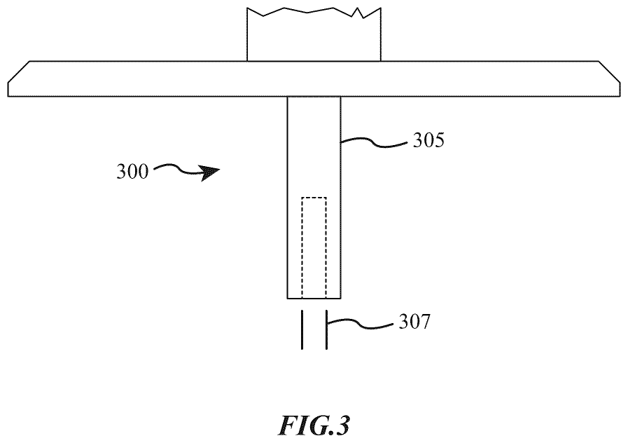

FIG. 3 shows an alternate embodiment of the anchor assembly with a first section 305 having an inner diameter 307 for receiving an optional guide pin (not shown) suitably secured to the pool or pool deck floor inside the pool hole.

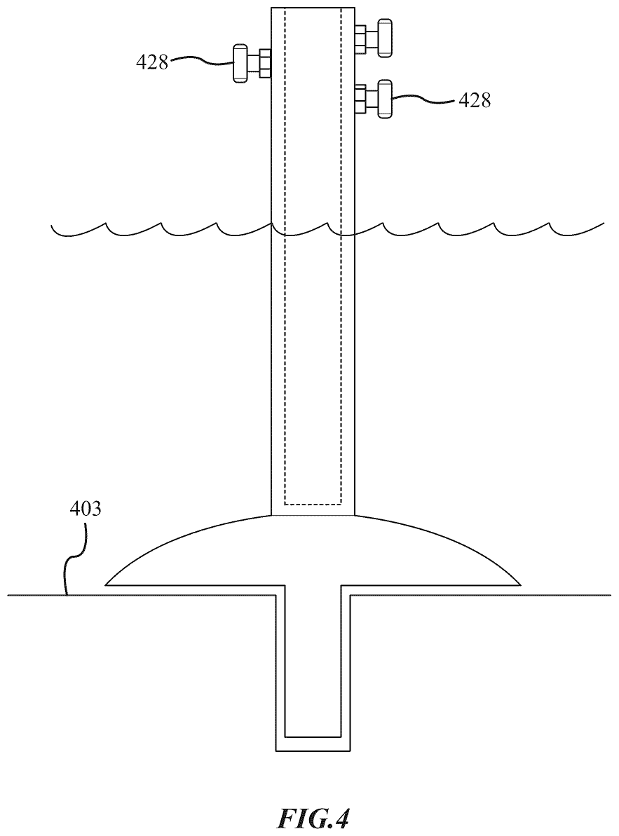

FIG. 4 is side elevation view of the anchor assembly shown in FIG. 1 with the tightening lugs 428 safely above the water level of, for example, 9 to 18 inches from the pool bottom 403.

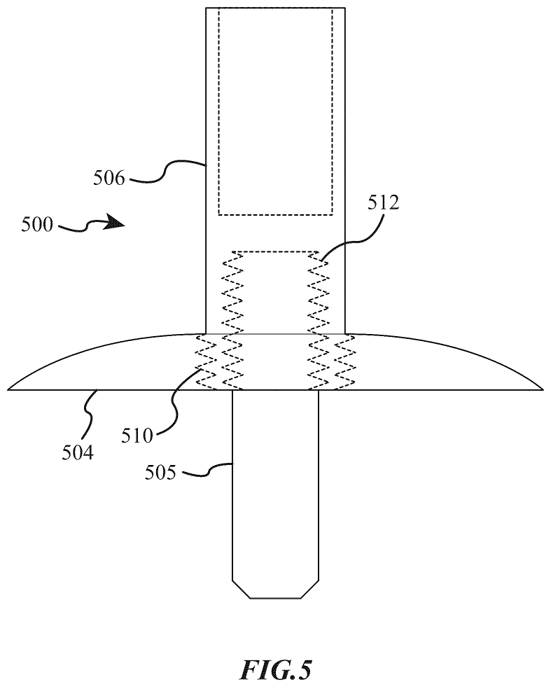

FIG. 5 shows an embodiment of an anchor assembly 500 wherein a first section 505 is screwed into pole support 506 using threads 512 (and/or the base plate), and/or the base plate 504 is threadedly engaged about the circumference of the pole support 506 at threads 510.

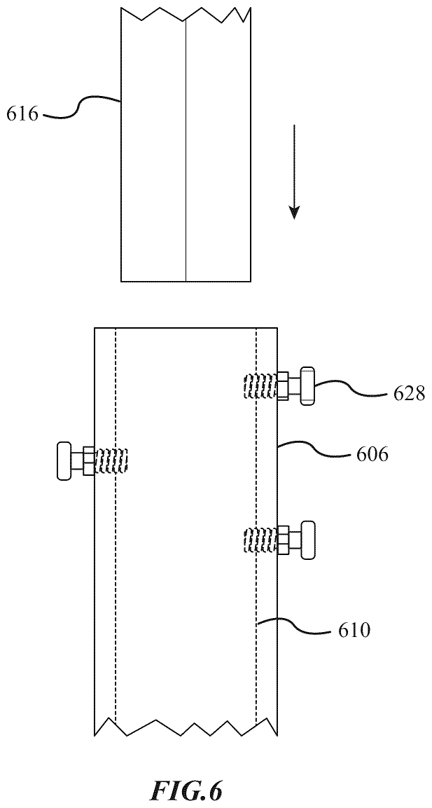

FIG. 6 is a close-up view of an umbrella pole 616 configured to be slidably received within the inner diameter 610 of pole support 606 in accordance with the invention.

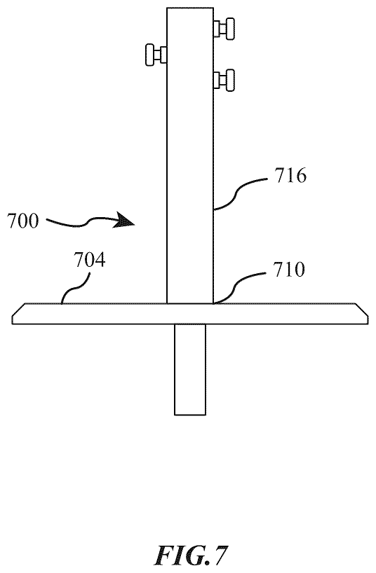

Referring now to FIG. 7, the base plate 704 may be secured to the pole support 706 along a radial junction 710 by a water proof weld. Alternatively, the radial junction my comprise a resiliently deformable material to absorb and relieve stresses to do wind and hijinks from young adults.

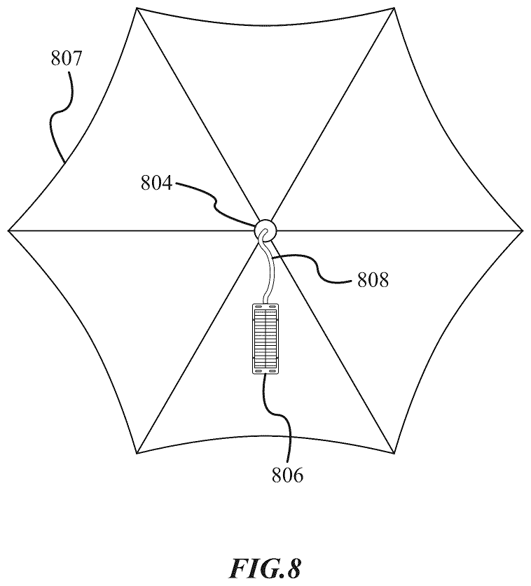

Referring now to FIG. 8, one embodiment of the anchor assembly includes an unfolded umbrella 802 attached to an umbrella pole 804 and equipped with a photovoltaic device 806 such as a solar panel having an electrical wire 808 extending therefrom. In one embodiment, the solar panel me be flexible and either integrated into or otherwise secured to the umbrella material.

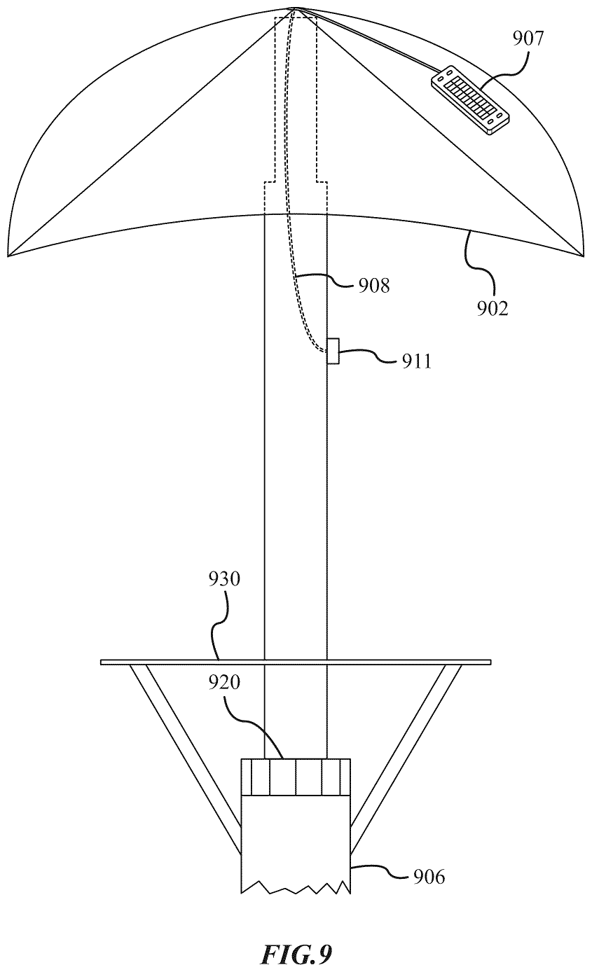

FIG. 9 is a side elevation view of an embodiment of the anchor assembly of FIG. 8 showing a pole support 906, an umbrella pole 916 slidably received therewithin, a rotational tightening mechanism 920 configured to impede relative axial and/or rotational movement between pole 916 and support 906, and a table 930 secured to umbrella support 906 through a plurality of brackets 940 disposed at respective angles relative to table 930 and support 906. FIG. 9 further illustrates an umbrella 902 equipped with a solar panel 907 connected through a wire 908 to a USB port or other electrical connector 911. In a preferred embodiment, the wire 908 suitably extends along an axial chamber within umbrella pole 916.

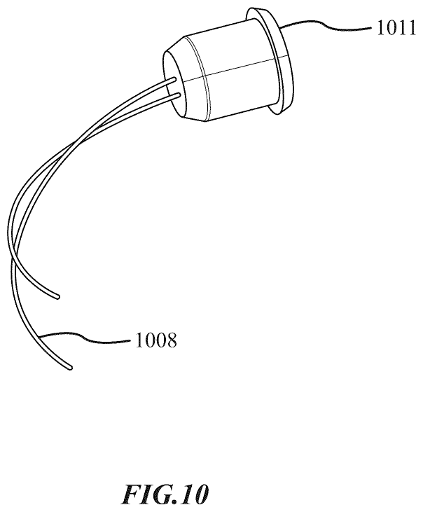

FIG. 10 is a top view of an exemplary embodiment of a device (e.g., USB) port 1011 and distal end of the connecting wire 1008 shown in FIG. 9.

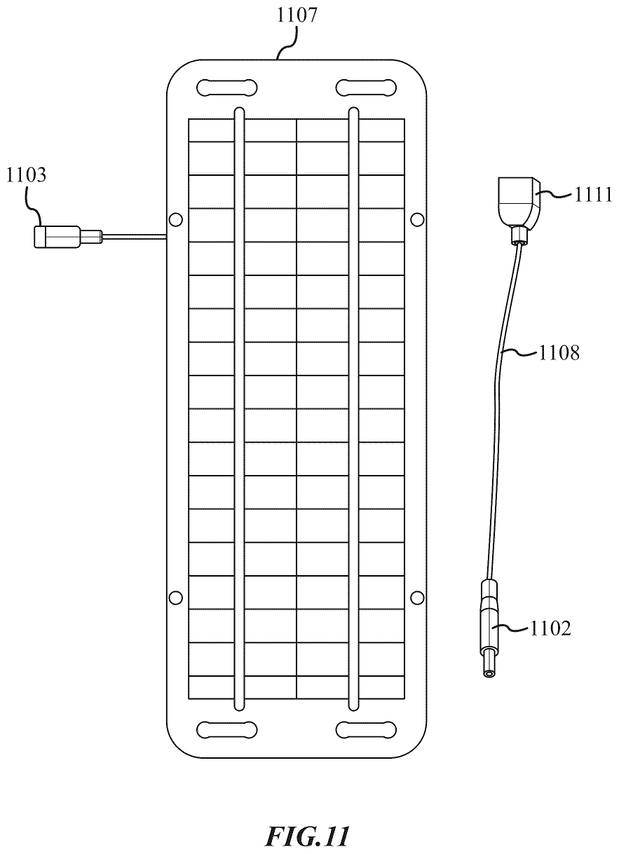

FIG. 11 is close up view of a solar panel 1107 and connecting wire 1108 having a port 1111 at one end and a first charging connector 1102 for connecting to a second charging connector 1103.

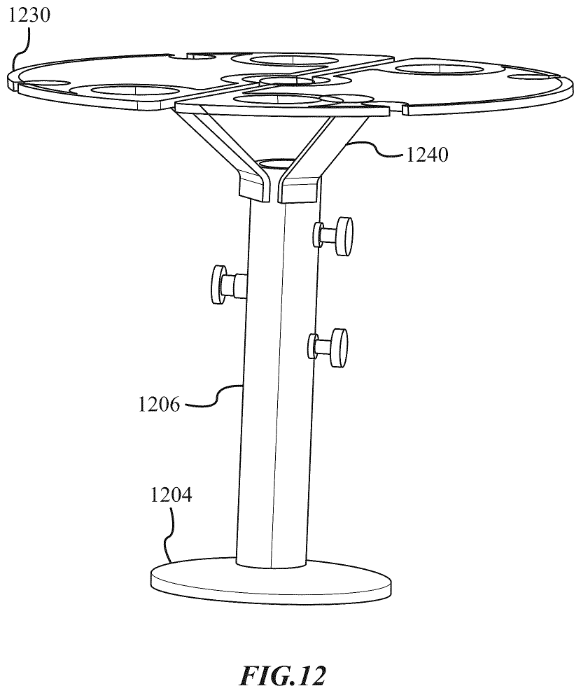

Referring now to FIG. 12, an alternate embodiment of the anchor assembly includes an optional table 1230 mounted proximate the top end of the umbrella pole support 1206 by a plurality of brackets 1240.

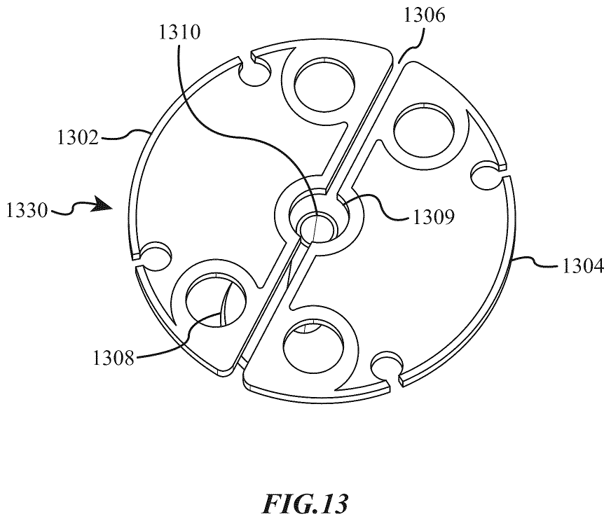

FIG. 13 is a perspective view of an exemplary table 1330 comprising a first half 1302 and a second half 1304 separated by a gap 1306 mounted proximate the top end of the pole support 1310. When assembled, the umbrella pole (not shown in FIG. 13) is received within the pole support and extends upwardly through a central hole 1320 defined by respective first and second table halves 1302, 1304.

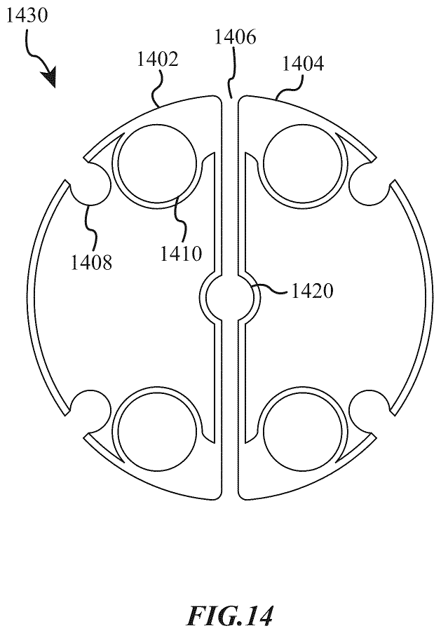

FIG. 14 is a schematic top plan view of a portion of the top surface of a table 1430 comprising first and second table halves 1402, 1404 defining a gap 1406 and a center hole 1420. Also shown are a plurality of beverage holders 1408 and access holes 1410 as discussed in greater detail below.

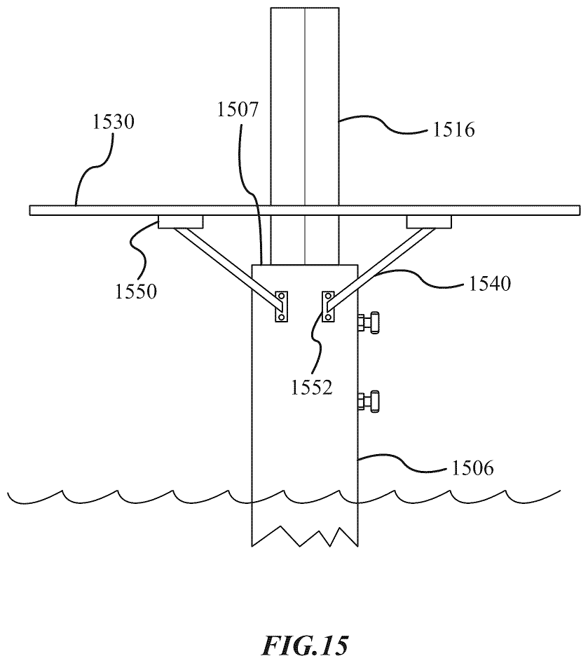

FIG. 15 is a side elevation view of an exemplary embodiment of a table 1530 mounted proximate the top end 1507 of a pole support 1506 with a plurality of angled brackets 1540. The brackets 1540 are suitably attached at one end to the underside of the table with fasteners 1550, and at the other end to the pole support 1506 with fasteners 1552.

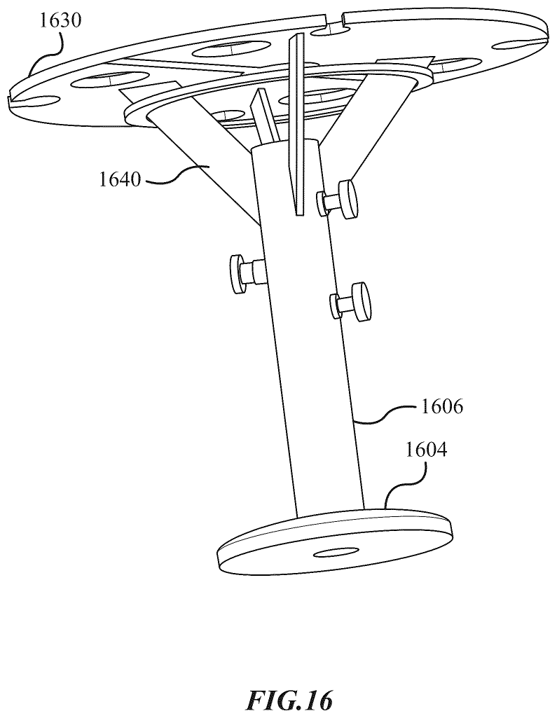

FIG. 16 is a perspective view of a table 1630 when viewed from the underside of the table, showing brackets 1640 attaching the table to the pole support 1606. in accordance with the present invention.

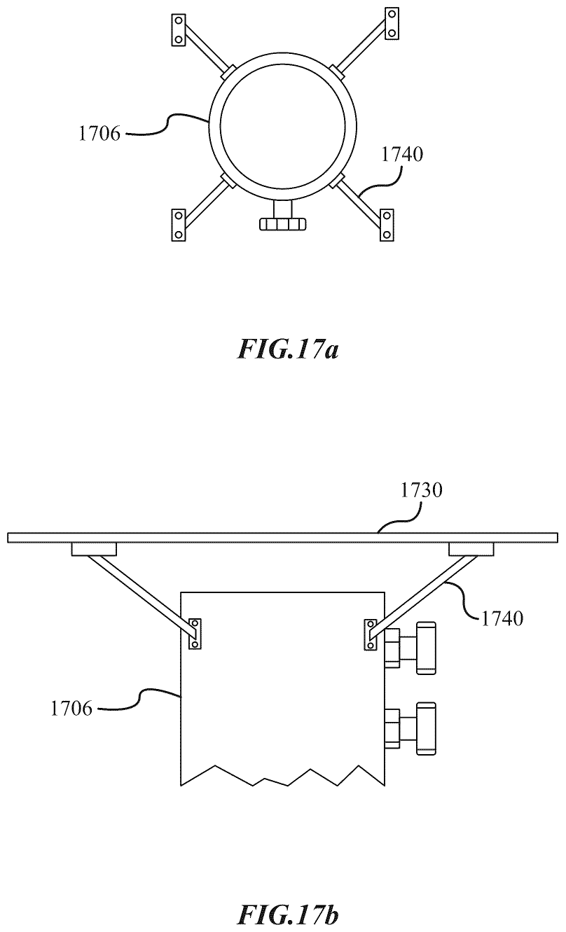

FIG. 17A is a top plan view of the pole support 1706 and table mounting brackets 1740 with the table top removed for clarity.

FIG. 17B is a side elevation view of a table 1730, table mounting brackets 1740, and pole support 1706 in accordance with a preferred embodiment.

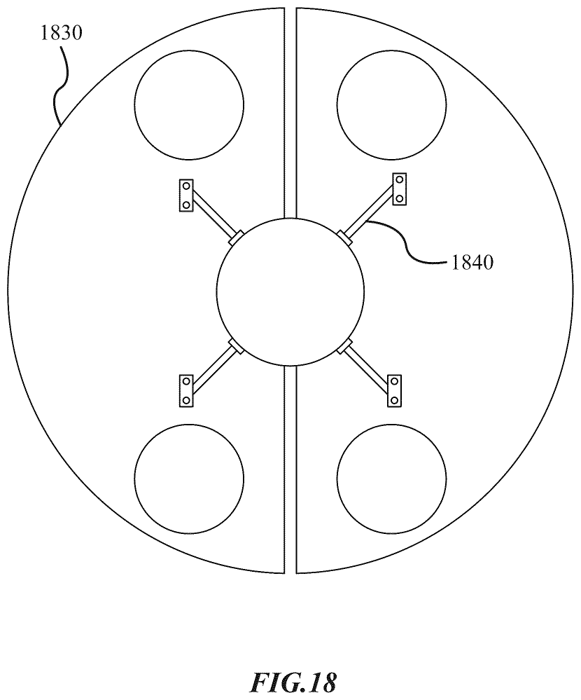

FIG. 18 is bottom plan view of a table 1830 shown in FIG. 17B showing brackets 1840.

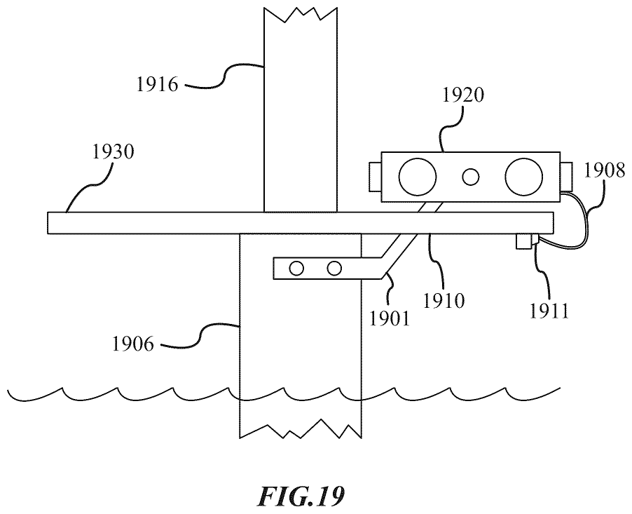

Referring now to FIG. 19, a side elevation view of one embodiment shows an optional accessory 1920 such as stereo speakers mounted to the pole support 1906 via a bracket 1901 extending through an access relief 1910 in the table top and powered through a charging port 1911 such as a USB port.

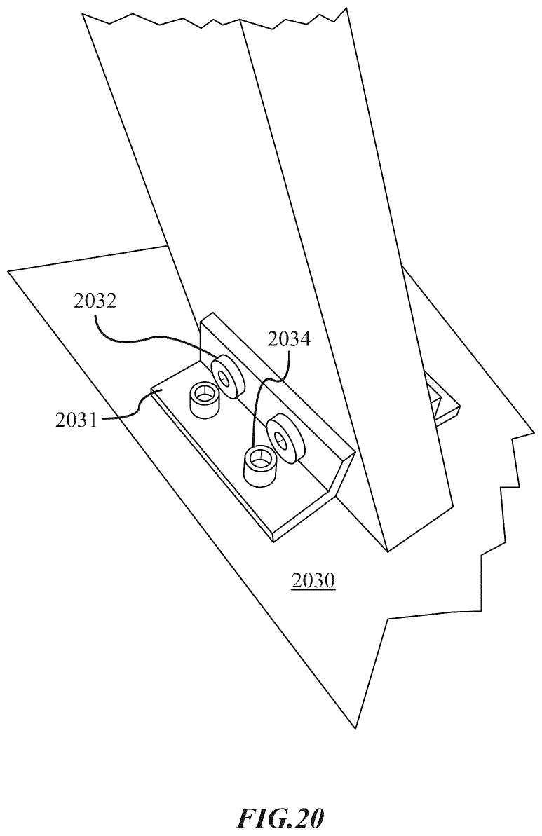

FIG. 20 is a perspective view of the underside of a table 2030 including an attachment bracket 2031, for example an L-shaped bracket, configured to be secured to a plurality of support legs 2140 with a plurality if leg mount fasteners 2032 (e.g., screws, bolts) and further configured to be secured to the underside of the table with a plurality of table mount fasteners 2034.

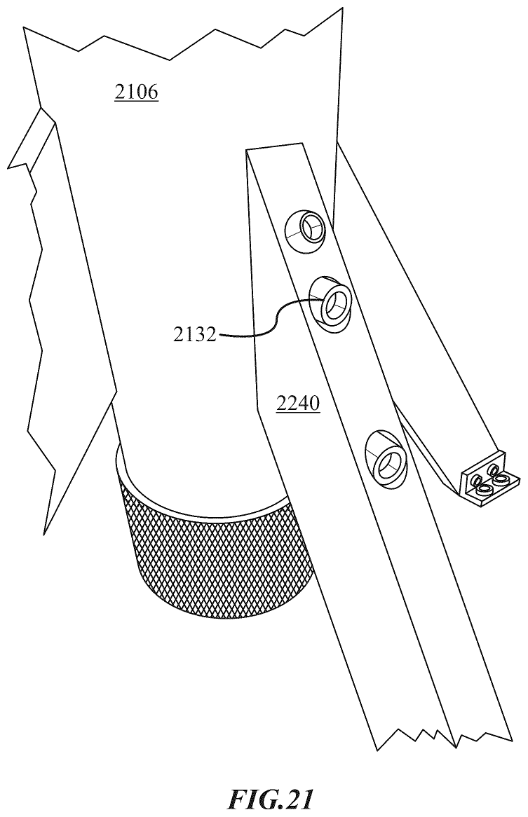

FIG. 21 is a perspective view of an attachment bracket 2240 (analogous to bracket 2140 of FIG. 20) shown attached to the outer diameter of an umbrella support sleeve 2106 using a plurality of fasteners 2132.

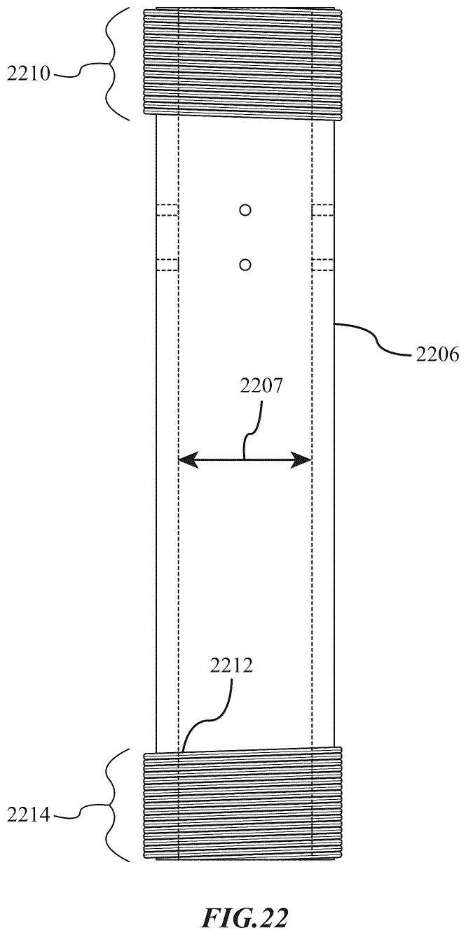

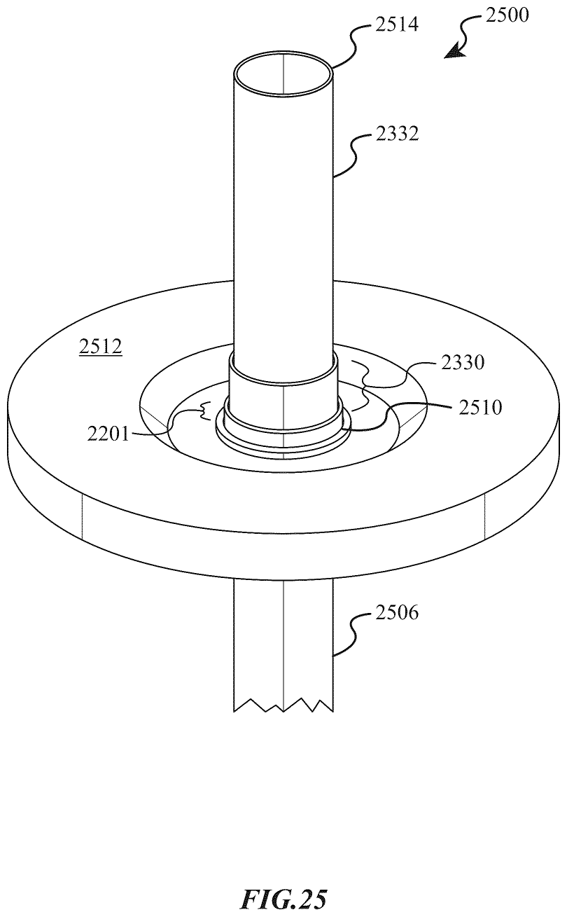

In accordance with an alternate embodiment, the adapter may comprise separate components designed to be secured together during installation as shown in FIGS. 22-25. For example, and with momentary reference to FIG. 25, the adapter 2500 may comprise an adapter tube 2506 configured to be secured within a hole 2510 in a base plate 2512, and a pin 2514 configured to be secured to the adapter tube and received with the pool hole (or pool hole sleeve).

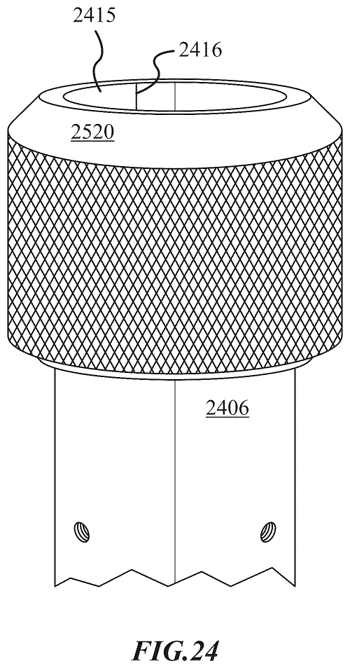

With particular reference to FIGS. 22 and 25, a suitable adapter 2206 comprises a hollow tube having an inner diameter 2207, an upper external (outer diameter) thread 2210, and respective lower internal and external threads 2212 and 2214. As shown in FIG. 24, a cap 2410 (e.g., aluminum) is configured to screw onto the top of adapter tube 2406. The cap 2410 includes a resiliently deformable (e.g., plastic) ring 2415 having one or more cutouts 2416 extending along the axial length thereof and configured to receive the bottom end on an umbrella pole therewithin. After the umbrella pole is slidable received within the adapter tube 2496, the cap 2410 may be tightened, urging an upper conical portion 2520 of the cap downwardly, thereby compressing the plastic ring 2415 circumferentially about the outer diameter of the umbrella pole. The tightening interaction among the adapter tube 2406, its upper threads 2210, cap 2410, and ring 2415 effectively secures the umbrella pole against rotational and axial movement within adapter tube 2406.

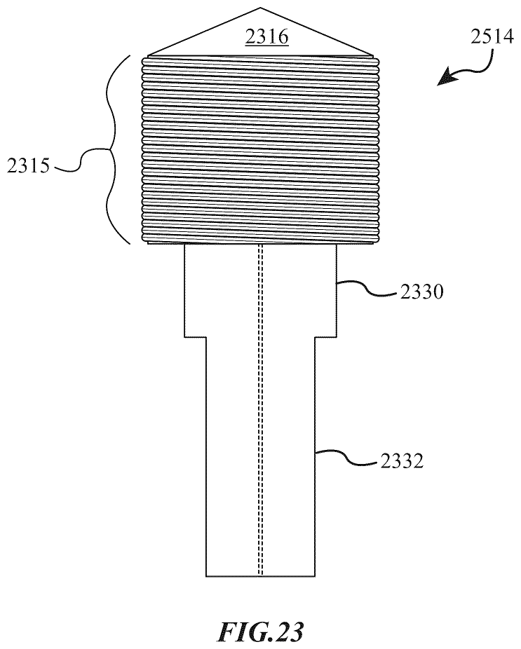

Referring now to FIGS. 23 and 25, the pin 2514 suitably includes external upper threads 2315 configured to threadably engage the internal threads 2212 of the adapter tube, a first outer diameter 2330 and a second, smaller outer diameter 2332. When inserted into a standard pool hole sleeve, the outer diameters 2330 and 2332 mate with corresponding inner diameters of the [plastic sleeve typically installed into original equipment pool and deck holes.

Referring again to FIG. 23, conical portion 2316 of pin 2514 is configured to center, using gravity, the lower and of the hollow umbrella pole within the adapter tube while resting on the upper surface of the conical portion 2316.

The foregoing discussion focused on after-market products to be used with presently known pool holes having plastic sleeves installed therewithin. In contrast, the ensuing discussion focuses on an entirely new metallic (e.g. stainless steel, aluminum) sleeve for use during initial pool construction. Although the inner shape and dimensions of the new metal sleeve correspond to the inner shape and dimensions of current plastic pool hole sleeves, the outer shape and dimensions are larger than current pool holes.

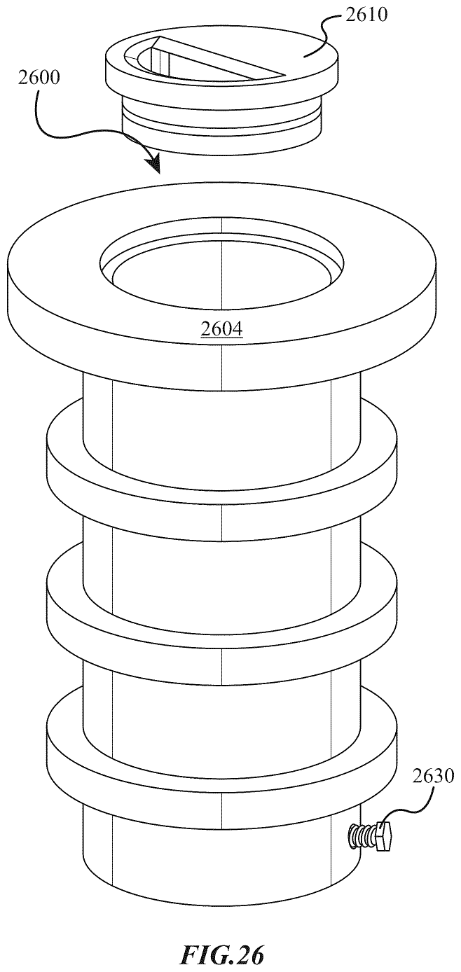

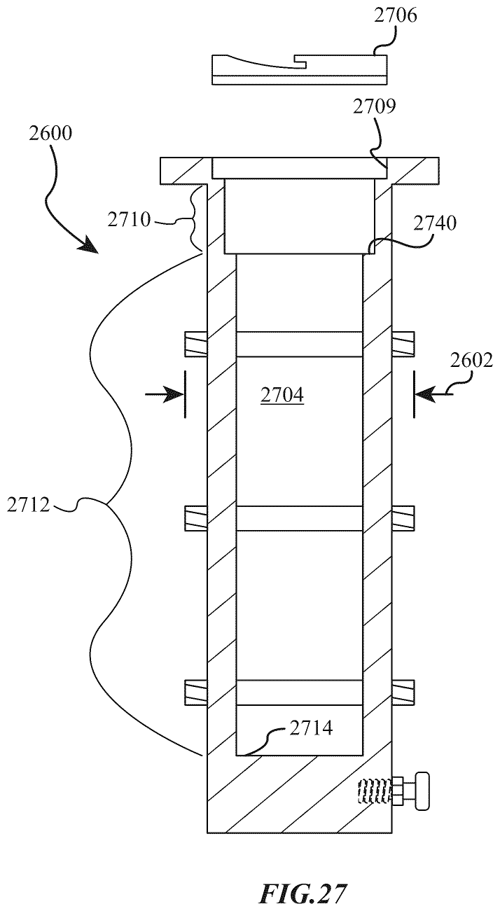

Referring now to FIGS. 26 and 27, a metallic pool sleeve 2600 comprises a top surface 2604 designed to be co-planar with the pool or deck bottom within which it is installed, an internal chamber 2605, a cap 2606 having an O-ring 2608 and configured to inserted into the top hole of chamber 2604 to provide a releasable water seal for the internal chamber. Sleeve 2600 also includes a grounding screw 2630 configured to provide electrical grounding for the sleeve.

Referring now to FIGS. 23 and 27, pool hole sleeve 2600 comprises a cap 2706 and an O-ring diameter 2709 configured to accommodate O-ring 2608, a first inner diameter 2710 configured to mate with first outer diameter 2330 of pin 2514, and a second inner diameter 2712 configured to mate with second diameter 2332 of pin 2514. In this war, a shoulder 2340 of pin 2514 abuts shelf 2740 of sleeve 2600 when pin 2514 is received within sleeve 2600. At the same time a terminal end 2350 of pin 2514 is configured to rest against a bottom surface 2714 of sleeve 2600.

An adapter assembly is thus provided for use within an installed pool hole, the adapter including a base plate surrounding the top of the pool hole and having a bottom surface configured to rest on the pool surface proximate the pool hole; an umbrella support extending upwardly from the base plate; and a pin extending from the bottom of the base plate and configured to be inserted into the pool hole sleeve.

An upper end of the umbrella support may include a hollow chamber having an inner diameter approximately equal to an outer diameter of a pool umbrella and configured to receive a bottom end of the umbrella pool.

The upper end of the umbrella support may include at least one tightening screw configured to resist axial and rotational movement of the umbrella pole relative to the umbrella support.

The tightening screw may include a screw head configured for manually tightening the screw.

The base plate, support, and pin may be of unitary construction.

In an embodiment, the base plate includes a hole having an axis substantially perpendicular to the base plate bottom surface, the hole having internal threads; the umbrella support includes a hollow bottom end having internal threads, and external ternal threads configured to engage the internal threads of the base plate hole; and the pin includes an upper end having external threads configured to engage the internal threads of the umbrella support.

The upper portion of the umbrella support may include a first bracket, and the adapter assembly may include a table having a second bracket; and a support leg having a first end secured to the first bracket and a second end secured to the second bracket to thereby secure the table to the adapter assembly.

The table may include respective first and second planar segments separated by linear space, and each of the planar segments is secured to the umbrella support by a first bracket, a second bracket, and a support leg.

The adapter assembly may also include an umbrella having a pole with an internal axial chamber, a solar panel secured to a top surface of the umbrella, and a wire extending from the solar panel through the axial chamber and terminating at a port disposed on an outer circumferential surface of the umbrella support.

An umbrella system is provided for use with a pool hole installed in a pool bottom or underwater pool deck, including: an umbrella pole adapter including a base plate, a pin extending downwardly from said base plate and receivable within the pool hole, and an umbrella support extending upwardly from said base plate having a first bracket proximate a top portion of the support, the umbrella support being configured to receive an umbrella pole therewithin; a table having a second bracket; and a leg having a first end configured to be secured to said first bracket and a second end configured to be secured to said second bracket to thereby secure said table to said umbrella pole adapter.

The system may also include a solar panel secured to a top surface of said umbrella, including a wire extending from the solar panel and terminating at a terminal end; and a USB port integrated into an outer circumferential surface of an upper portion of the umbrella support and connected to said terminal end of said wire.

A mobile telephone charging station integrated into a pool deck umbrella assembly is provided, including: a pool hole adapter comprising a base plate, a pin extending downwardly from the base plate and configured for receipt within the pool hole, and an umbrella pole support tube extending upwardly from the base plate; and a solar panel configured to be secured to a top surface of an umbrella and having a wire extending therefrom and terminating at a charging port integrated into the umbrella pole support.

The charging station may include: a table having a first bracket disposed on an underside thereof; a second bracket disposed on an outer surface of an upper portion of said umbrella pole support tube; and an angled support member having a first end fastened to said first bracket and a second end fastened to said second bracket to thereby secure said table to said umbrella pole support tube.

The charging station may also include: a member having a top conical surface extending axially and upwardly through an interior portion of the umbrella support; and an umbrella pole having a hollow lower portion configured to receive the top conical surface therewithin to thereby use gravity to center the umbrella pole within the umbrella support.

An umbrella adapter assembly for use with a pool deck sleeve is provided, the assembly including: a base plate having a central hole with internal threads; an adapter tube having a hollow upper portion configured to receive an umbrella pole therewithin and a lower portion having first internal and second external threads, the second external threads being configured to threadedly engage the base plate internal threads; a pin having an upper threaded portion configured for threaded engagement within the first internal threads of said adapter tube, and a downwardly extending pin configured for receipt within said pool deck sleeve; and a manually manipulable cap threadedly engaging the hollow upper portion the adapter tube and having a resiliently deformable ring disposed between the cap and the adapter tube such that rotating the cap squeezes the ring to thereby secure an umbrella pole therewithin.

The cap may include a conical top portion configured to be drawn axially downward upon said rotating the cap to thereby urge the ring inwardly against an outer diameter of the umbrella pole.

A metallic pool hole sleeve for use within a pool deck hole is provided, the sleeve including: a cap having a circumferential O-ring; and an internal chamber having a top outer diameter configured to removable receive said cap and said O-ring; wherein the internal chamber comprises a bottom segment having a diameter in the range of about 1.6 inches, and a top diameter extending axially between said top outer diameter and said bottom segment and having a diameter of about 1.68 inches.

The cap may include a manually graspable portion configured to facilitate manual lifting of the cap from said sleeve.

The sleeve may also include an electrical conductor extending outwardly from said bottom segment and configured to provide electrical grounding to said sleeve.

While there has been illustrated an enabling description of various embodiments including the best mode known to the inventors, it will be understood by those skilled in the art that various changes and modifications may be made and equivalents may be substituted for various elements without departing from the scope of the invention. Therefore, it is intended that the inventions disclosed herein not be limited to the particular embodiments disclosed, but that the invention will include all embodiments falling within the literal and equivalent scope of the appended claims.

I claim:

1. An adapter assembly for use within an installed pool hole, the adapter comprising:
a base plate surrounding the top of the pool hole and having a bottom surface configured to rest on the pool surface proximate the pool hole;
an umbrella support extending upwardly from the base plate; and
a pin extending from the bottom of the base plate and configured to be inserted into the pool hole sleeve.

2. The assembly adapter of claim 1, wherein an upper end of the umbrella support comprises a hollow chamber having an inner diameter approximately equal to an outer diameter of a pool umbrella and configured to receive a bottom end of the umbrella pool.

3. The adapter assembly of claim 2, wherein the upper end of the umbrella support comprises at least one tightening screw configured to resist axial and rotational movement of the umbrella pole relative to the umbrella support.

4. The adapter assembly of claim 3, wherein the tightening screw comprises a screw head configured for manual tightening of the screw.

5. The adapter assembly of claim 1 wherein the base plate, support, and pin are of unitary construction.

6. The adapter assembly of claim 1 wherein:
the base plate comprises a hole having an axis substantially perpendicular to the base plate bottom surface, the hole having internal threads;
the umbrella support comprises a hollow bottom end having internal threads, and external ternal threads configured to engage the internal threads of the base plate hole; and
the pin comprises an upper end having external threads configured to engage the internal threads of the umbrella support.

7. The adapter assembly of claim 1, wherein the upper portion of the umbrella support comprises a first bracket, and the adapter assembly further includes:
a table having a second bracket; and
a support leg having a first end secured to the first bracket and a second end secured to the second bracket to thereby secure the table to the adapter assembly.

8. The adapter assembly of claim 7, wherein the table includes respective first and second planar segments separated by linear space, and each of the planar segments is secured to the umbrella support by a first bracket, a second bracket, and a support leg.

9. The adapter assembly of claim 1, further comprising an umbrella having a pole with an internal axial chamber, the adapter assembly further including:
a solar panel secured to a top surface of the umbrella; and
a wire extending from the solar panel through the axial chamber and terminating at a port disposed on an outer circumferential surface of the umbrella support.

10. The adapter assembly of claim 9, wherein the port comprises a USB port.

11. An umbrella system for use with a pool hole installed in a pool bottom or underwater pool deck, the system comprising:
an umbrella pole adapter including a base plate, a pin extending downwardly from said base plate and receivable within the pool hole, and an umbrella support extending upwardly from said base plate having a first bracket proximate a top portion of the support, the umbrella support being configured to receive an umbrella pole therewithin;
a table having a second bracket; and
a leg having a first end configured to be secured to said first bracket and a second end configured to be secured to said second bracket to thereby secure said table to said umbrella pole adapter.

12. The system of claim 11, further comprising:
a solar panel secured to a top surface of said umbrella, including a wire extending from the solar panel and terminating at a terminal end; and
a USB port integrated into an outer circumferential surface of an upper portion of the umbrella support and connected to said terminal end of said wire.

13. A mobile telephone charging station integrated into a pool deck umbrella assembly, comprising:
a pool hole adapter comprising a base plate, a pin extending downwardly from the base plate and configured for receipt within the pool hole, and an umbrella pole support tube extending upwardly from the base plate;
a solar panel configured to be secured to a top surface of an umbrella and having a wire extending therefrom and terminating at a charging port integrated into the umbrella pole support.

14. The charging station of claim 13, further comprising:
a table having a first bracket disposed on an underside thereof;
a second bracket disposed on an outer surface of an upper portion of said umbrella pole support tube; and
an angled support member having a first end fastened to said first bracket and a second end fastened to said second bracket to thereby secure said table to said umbrella pole support tube.

15. The charging station of claim 13 further comprising:
a member having a top conical surface extending axially and upwardly through an interior portion of the umbrella support; and
an umbrella pole having a hollow lower portion configured to receive the top conical surface therewithin to thereby use gravity to center the umbrella pole within the umbrella support.

16. An umbrella adapter assembly for use with a pool deck sleeve, the assembly comprising:
a base plate having a central hole with internal threads;
an adapter tube having a hollow upper portion configured to receive an umbrella pole therewithin and a lower portion having first internal and second external threads, the second external threads being configured to threadedly engage the base plate internal threads;
a pin having an upper threaded portion configured for threaded engagement within the first internal threads of said adapter tube, and a downwardly extending pin configured for receipt within said pool deck sleeve; and
a manually manipulable cap threadedly engaging the hollow upper portion the adapter tube and having a resiliently deformable ring disposed between the cap and the adapter tube such that rotating the cap squeezes the ring to thereby secure an umbrella pole therewithin.

17. The assembly of claim 16, wherein the cap comprises a conical top portion configured to be drawn axially downward upon said rotating the cap to thereby urge the ring inwardly against an outer diameter of the umbrella pole.

18. A metallic pool hole sleeve for use within a pool deck hole, the sleeve comprising:
a cap having a circumferential O-ring; and
an internal chamber having a top outer diameter configured to removable receive said cap and said O-ring;
wherein the internal chamber comprises a bottom segment having a diameter in the range of about 1.6 inches, and a top diameter extending axially between said top outer diameter and said bottom segment and having a diameter of about 1.68 inches.

19. The sleeve of claim 18 wherein said cap comprises a manually graspable portion configured to facilitate manual lifting of the cap from said sleeve.

20. The sleeve of claim 18, further comprising an electrical conductor extending outwardly from said bottom segment and configured to provide electrical grounding to said sleeve.
